(19) United States
(12) Patent Application Publication
(10) Pub. No.: US 2020/0160295 A1
(43) Pub. Date: May 21, 2020

(54) PROCESSING SETS OF INSTALLMENT TRANSACTIONS OF MULTIPLE USERS BASED ON INSTALLMENT PLANS

(71) Applicant: MASTERCARD INTERNATIONAL INCORPORATED, Purchase, NY (US)

(72) Inventors: Venkatesh Jagalpure, Pune (IN); Gaurav K. Patni, Pune (IN); Ketan Shrikant Joshi, Pune (IN); Ankur Arora, New Dehli (IN); Rakesh Patel, Gurgaon (IN); Aditya Koduri, Gurgaon (IN)

(21) Appl. No.: 16/197,068

(22) Filed: Nov. 20, 2018

(51) Int. Cl. G06Q 20/10; G06Q 20/22; G06Q 20/20; G06Q 20/40

(52) U.S. Cl. CPC G06Q 20/102; G06Q 20/405; G06Q 20/204; G06Q 20/29

(57) ABSTRACT

The disclosure herein describes processing transactions from multiple users as installment transactions based on an installment plan. A first transaction associated with a first user is received. The transaction includes an installment indicator and a transaction value, the installment indicator indicating that an installment plan is requested, and wherein the transaction value is less than a total value threshold required to qualify for the installment plan. At least one second transaction associated with at least one second user is identified associated with the installment plan. Based on a sum of the transactions exceeding the total value threshold, the first transaction is associated with the at least one second transaction as an installment transaction set associated with the installment plan. The installment transaction set is then provided for processing as installment transactions. The described system enables users to access installment payment services by combining transaction totals with other users.

### BACKGROUND

Currently, some financial entities (e.g., issuing banks, etc.) provide the option to use installment plans based on defined eligibility criteria, including a minimum total amount to be paid by the installment payments, associated interest rates, and fees. In many cases, the eligibility criteria are difficult to meet for many users, such that the installment plan services are out of reach for the majority of people. Further, in some cases, the issuers may enable users to make use of installment plans based on multiple transactions, enable a user to batch a variety of transactions in order to reach the minimum total amount required by the installment plan. However, this still requires the user to spend the minimum total amount, which may still put the installment plan service outside the reach of many users based on their typical purchasing patterns.

Many users may be interested in making use of installment payment services in certain situations, such as sudden expenses (e.g., car repairs, unexpected travel costs, etc.), but for many issuing banks, it does not make financial sense to provide the installment payment services for these relatively small expenditures due to the risks attached to providing such a service and the additional administration costs.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method and system for processing transactions from multiple users as installment transactions based on an installment plan is described. Transaction data of a first transaction associated with a first user is received by a first entity, wherein the transaction data of the first transaction includes an installment indicator and a transaction value, the installment indicator indicating that an installment plan is requested for the first transaction, and wherein the transaction value is less than a total value threshold required to qualify for the installment plan. At least one second transaction associated with at least one second user is identified, wherein the at least one second transaction includes an installment indicator associated with the installment plan. Based on a sum of the transaction value of the first transaction and at least one transaction value of the at least one second transaction exceeding the total value threshold, the first transaction is associated with the at least one second transaction as an installment transaction set associated with the installment plan. The installment transaction set is then provided to a second entity for processing as installment transactions.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is an exemplary block diagram illustrating a system configured for processing transactions using installment plans according to an embodiment;

FIG. 2 is an exemplary flow chart illustrating processing of transactions from multiple users as installment transactions based on an installment plan according to an embodiment;

FIG. 3 is an exemplary flow chart illustrating processing of transactions from multiple users as installment transactions based on a plurality of installment plans arranged in tiers according to an embodiment;

FIG. 4 is an exemplary sequence diagram illustrating processing of transactions from multiple users as installment transactions based on a plurality of installment plans including pre-approving the transactions according to an embodiment;

FIG. 5 is an exemplary sequence diagram illustrating processing of transactions from multiple users as installment transactions based on a plurality of installment plans including approving transactions after initiation according to an embodiment; and

FIG. 6 illustrates a computing apparatus according to an embodiment as a functional block diagram.

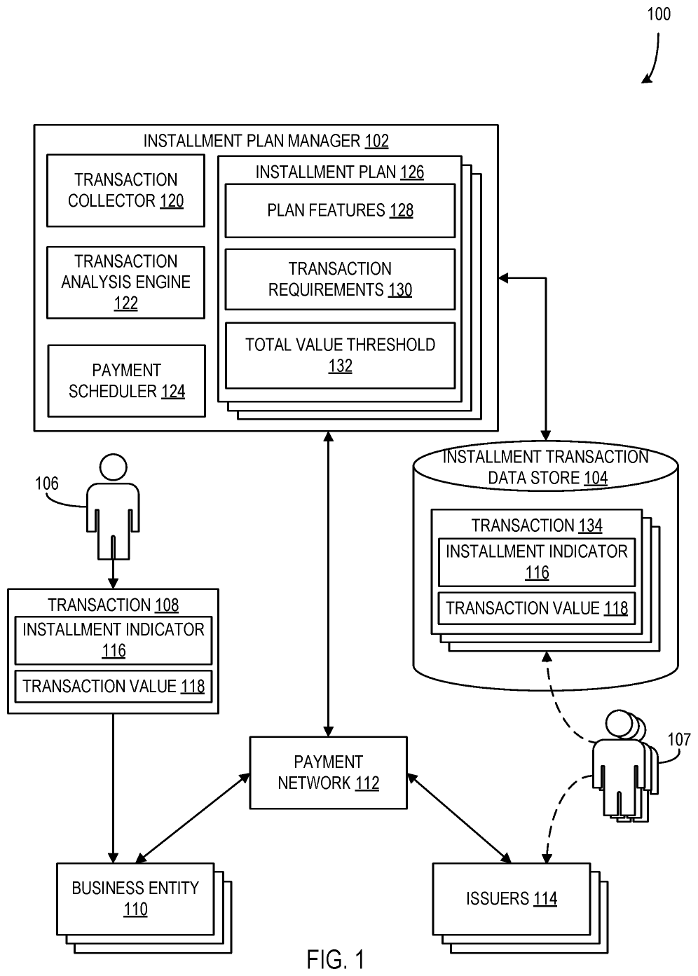

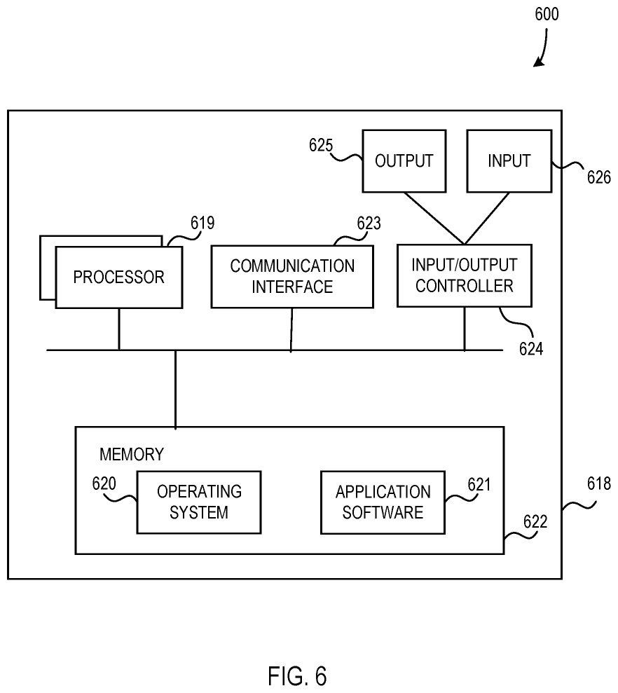

Corresponding reference characters indicate corresponding parts throughout the drawings. In FIGS. 1 to 6, the systems are illustrated as schematic drawings. The drawings may not be to scale.

### DETAILED DESCRIPTION

Aspects of the disclosure provide a system and method for processing transactions from multiple users as installment transactions based on an installment plan. A first transaction of a first user is received by the described system, wherein the transaction includes an installment indicator and a transaction value, the installment indicator indicating that an installment plan is requested. The transaction value is less than a total value threshold required to qualify for the installment plan. A second set of transactions of other users are identified, wherein the second set of transactions include installment indicators associated with the installment plan as well. Based on the combined transaction value of the first transaction and transaction values of the second transactions meeting or exceeding the total value threshold, the first transaction is associated with the second transactions as an installment transaction set associated with the installment plan. The installment transaction set is then provided to another entity, such as an issuer, for processing as separate installment transactions.

The described installment plan management system provides automated analysis of transactions with respect to installment plans, combination of transactions from multiple users into installment transaction sets, and processing of the installment transaction sets associated with installment plans as separate or fractional installment payments for each associated user. Many installment plans as defined by issuers have requirements that are difficult for individual users to meet, and enabling multiple users to seamlessly take advantage of a single installment plan substantially expands the potential number of users who are able to make use of such services. The described system operates in an unconventional way by automatically matching transactions to installment plans and combining groups of transactions of multiple users to satisfy the plan requirements, thereby providing users with a low effort means to obtain installment payment approval without direct interaction with issuer representatives or their fellow users. Additionally, users' installment payments are optimized based on their transactions, transaction history, payment history, or the like when the system automatically identifies the most advantageous installment plan for which they are eligible. Finally, issuers are provided with more opportunities to provide a useful service to their users while potentially reducing the risk of offering installment plans by diversifying the risk of non-payment among a variety of users.

The described system performs the described operations that enable automatic satisfaction of established installment plans and scheduling and processing of installment payments associated therewith, providing a reduction of required processing resources of issuers or other financial entities associated with the installment plan and/or transactions. Further, the automatic identification of transactions of multiple users to fill installment plan requirements provides a reduced burden of user input to a computer for users and other associated users, who might otherwise need to manually arrange for sharing responsibilities of an installment plan among each other in order to take advantage of the service.

FIG. 1 is an exemplary block diagram illustrating a system 100 configured for processing transactions (e.g., transaction 108, transactions 134, etc.) using installment plans (e.g., installment plans 126, etc.) according to an embodiment. The system 100 includes an installment plan manager 102 and associated installment transaction data store 104. Further, the system 100 includes a user 106 (e.g., a customer, etc.) that initiates a transaction 108 with a business entity 110 (e.g., a merchant, etc.) and other users 107 that are associated with transactions 134 and may have accounts with issuers 114. The transaction 108 is processed by the payment network 112 and an associated issuer 114 as would be understood by a person of ordinary skill in the art. The installment plan manager 102 and installment transaction data store 104 are illustrated as being part of or otherwise associated with payment network 112. While the description herein often describes the installment plan manager 102 and installment transaction data store 104 as part of the payment network 112, it should be understood that, in other examples, the installment plan manager 102 and/or the installment transaction data store 104 may be part of and/or associated with other elements or entities of the system (e.g., business entities 110, issuers 114, etc.) and/or with other elements not illustrated (e.g., an acquiring bank or other financial entity, etc.).

The transaction 108 initiated by the user 106 at a business entity 110 (e.g., at a store, etc.) may be processed according to known transaction processing operations as would be understood by a person of ordinary skill in the art unless otherwise described herein. The processing of the transaction 108 may further include more or different entities (e.g., acquiring banks or other financial entities, etc.) without departing from the description. In particular, processing of the transaction 108 may include authorization, authentication, clearing, and settlement operations as would be understood by a person of ordinary skill in the art.

In some examples, the installment plan manager 102 is a component of the payment network 112 that includes hardware, firmware, and/or software configured to automatically manage installment plans, evaluate transactions, and schedule installment payments (e.g., equated monthly installment (EMI) payments, etc.) as described herein. In some examples, the installment plan manager 102 includes software that is executed by at least one processor associated with at least one computing device (e.g., a server device, a plurality of cloud server devices, etc.). The associated installment transaction data store 104 is a data store component of the payment network 112 that stores data associated with transactions 134 that are associated with installment plans 126 and/or transactions 134 that are being or have been analyzed and/or evaluated in association with the installment plans 126.

The installment plan manager 102 is a component and/or platform that includes a transaction collector component 120, a transaction analysis engine 122, a payment scheduler 124, and one or more installment plans 126. While the installment plans 126 are illustrated as part of the installment plan manager 102, in alternative examples, the installment plans 126 may be stored in an associated data store (e.g., installment transaction data store 104, etc.) without departing from the description.

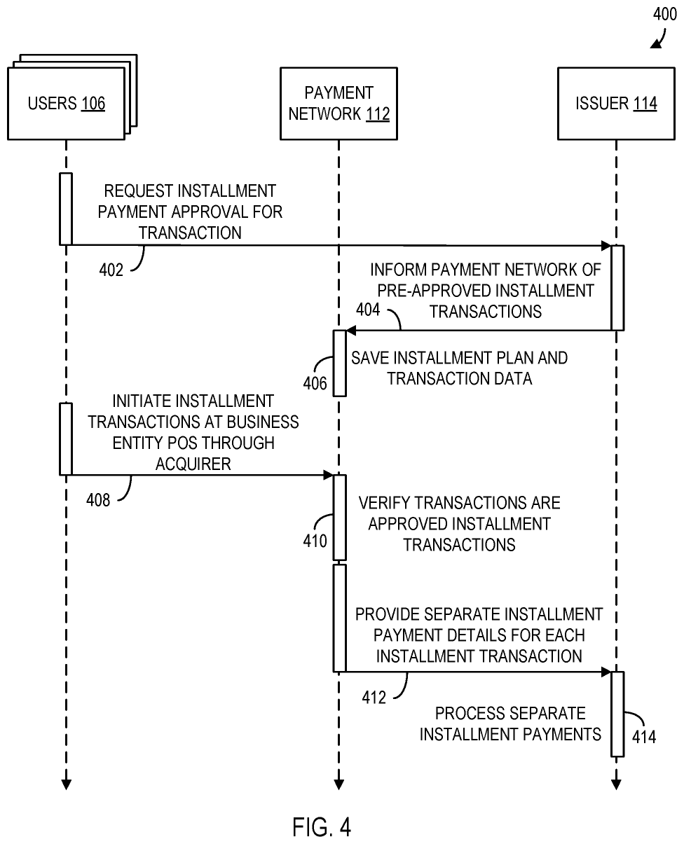

The transaction collector 120 is a component that includes hardware, firmware, and/or software configured to collect transactions and/or associated transaction data that is provided by the payment network 112 and/or other entities of the system 100 (e.g., the business entities 110, the issuer 114, the user 106, etc.). The transaction collector 120 may be configured to communicate with the payment network 112 to collect transaction data of transactions that have been initiated (e.g., transaction 108 as initiated by user 106 at the business entity 110, etc.). Further, the transaction collector 120 may be configured to collect transaction data of transactions from an associated issuer 114 and/or an associated business entity 110. For instance, the user 106 may apply for pre-approval of transaction 108 with the issuer 114 as described below with respect to FIG. 4. The transaction collector 120 may collect the transaction data for use by the installment plan manager 102 using a communication channel between the payment network 112 and issuer 114 (e.g., network connection and/or an associated application programming interface (API), etc.). Alternatively, or additionally, the transaction collector 120 may collect transaction data of the transaction 108 from the business entity 110 through an established communication channel if the business entity 110 is associated with an installment plan 126 (e.g., a business entity-offered installment plan 126, etc.). Upon collection of a transaction and/or associated transaction data, the transaction collector 120 may be configured to store the transaction in the installment transaction data store 104 (e.g., as a transaction 134, etc.).

In some examples, the transaction collector 120 is configured to collect the installment indicator 116 and transaction value 118 from the transaction 108. Further, other transaction data may be collected, such as a transaction identifier, business entity identifier, account information associated with the user 106's account (e.g., an account identifier, an associated issuer 114, etc.), date and time data, location data, transaction category data, etc. The installment indicator 116 may include an indication that the user 106 is interested in paying for the transaction using an installment plan 126. The installment indicator 116 may also indicate that the user 106 is interested in one or more particular installment plans 126 from the full set of possible installment plans 126 (e.g., the installment indicator 116 may include one or more installment plan identifiers that uniquely identify one or more installment plans 126 or plan features that the user 106 is interested in, etc.). The transaction value 118 indicates an amount that the user 106 is to pay for the transaction 108.

The transaction analysis engine 122 is a component that includes hardware, firmware, and/or software configured to analyze and/or evaluate transactions (e.g., transaction 108, etc.) to determine whether they satisfy the requirements of one or more installment plans 126. Upon transaction data of a transaction 108 being collected by the transaction collector 120, the transaction analysis engine 122 may be configured to access the collected transaction data, including the installment indicator 116 and transaction value 118. Then, the transaction analysis engine 122 may be configured to access the installment plans 126 and associated plan features 128, transaction requirements 130, and total value thresholds 132. The analysis engine 122 compares the transaction data to the features 128, requirements 130 and total value threshold 132 of one or more installment plans 126 and determines whether the associated transaction 108 satisfies the one or more installment plans 126.

In some examples, the transaction analysis identifies one or more installment plans 126 that may be identified in the installment indicator 116 of the transaction. Identifying the installment plans 126 for analysis of the transaction may include selecting specific installment plans 126 that are identified in the installment indicator 116 and/or selecting installment plans 126 that include plan features 128 that match one or more features that may be included in the installment indicator 116. In some examples, the transaction analysis engine 122 is configured to only analyze plans that are identified in this process. Alternatively, or additionally, the transaction analysis engine 122 may be configured to analyze installment plans 126 identified in this way first and, if transaction 108 does not satisfy any of the identified installment plans 126, the analysis engine 122 may expand the analysis to other installment plans 126 in order to identify a match for the transaction 108. Further, the installment indicator 116 may indicate whether the user 106 wants to also consider installment plans 126 that do not match the requested plans 126 or features 128 or not.

In some examples, plan features 128 of installment plans 126 may include features that define aspects of the installment plan 126 and associated installment payments. For instance, plan features 128 may include interest amount, fee amount(s), length of the installment payment period, number of installment payments over the period, frequency of payments over the period, rules governing early and/or late payment, recurring payment flags (e.g., if set, they may enable the payment network and/or issuer to automatically perform a transaction, etc.), etc. So, an installment indicator 116 may include a selected plan feature of “5% interest rate or less” and the transaction analysis engine 122 may be configured to identify only those installment plans 126 with an interest rate of 5% or less as a plan feature 128 as described above.

The transaction analysis engine 122 may be configured to compare and/or match the transaction data of the transaction 108 to the transaction requirements 130 of one or more installment plans 126. A transaction that matches an installment plan 126 is a transaction with associated transaction data that satisfies any and all transaction requirements 130 of the installment plan. Transaction requirements 130 may include, for instance, total value threshold requirements indicating a minimum transaction value for a single transaction, transaction category requirements indicating types of transactions that are required for the plan, business entity requirements, and/or payer requirements, such as payer transaction or payment history requirements (e.g., payer participation in other similar payment plans, successful payment of installment payments associated with other similar payment plans, etc.), payer credit score requirements, payer proof of income requirements, or the like. Such payer information may be collected by the transaction collector 120 or another component of the installment plan manager 102 or payment network 112 after obtaining any necessary acceptance from the user 106.

The transaction analysis engine 122 may further be configured to evaluate the transaction 108 with respect to the total value threshold 132 of an otherwise matching installment plan 126. The total value threshold 132 indicates a minimum transaction value amount required by the installment plan 126 to be initiated. The total value threshold 132 may be met by one transaction or multiple transactions in combination. For instance, if the transaction value 118 of the transaction 108 exceeds the total value threshold 132 of a matching installment plan 126, the installment plan 126 may be initiated based only on the transaction 108. Alternatively, if the transaction value 118 does not meet or exceed the total value threshold 132, the installment plan manager 102 may identify one or more other transactions (e.g., transactions 134, etc.) that match the installment plan 126 and have a sum of transaction values 118 with the transaction value 118 of the transaction 108 that meets or exceeds the total value threshold 132. In that case, the installment plan 126 may be initiated based on the multiple transactions with each associated user being responsible to pay fractional installment payments based on the proportion of each user's transaction to the total installment plan amount (e.g., a user whose transaction has a transaction value of $25 in an installment plan with a total installment plan amount of $100 would be responsible for paying a 25% fractional installment payment, etc.). In some examples, the total value threshold 132 functions as a maximum threshold, such that the associated installment plan 126 is initiated as soon as a set of transactions are identified that exceed the total value threshold 132. Alternatively, or additionally, the initiation of the installment plan 126 may occur only after a defined time period has expired and the set of identified transactions exceed the total value threshold 132. Other means of determining when the initiate an installment plan 126 based on the total value threshold 132 may also be used without departing from the description herein.

Installment plans 126 may be created, confirmed, or otherwise agreed to by one or more entities of the system 100. In some examples, the installment plans 126 may be created by the issuers 114 and provided to the payment network 112 and the installment plan manager 102 for management as described herein. An installment plan 126 may be associated with one issuer 114, such that all the transactions that are used to fulfill the installment plan 126 are associated with that issuer 114. Alternatively, or additionally, an installment plan 126 may be associated with multiple issuers 114, such that the transactions used to fulfill the installment plan 126 may be associated with one of the multiple issuers 114 that has created or confirmed use of the installment plan 126. This issuer 114 association may be stored with the installment plan 126 in the form of a transaction requirement 130 as described herein.

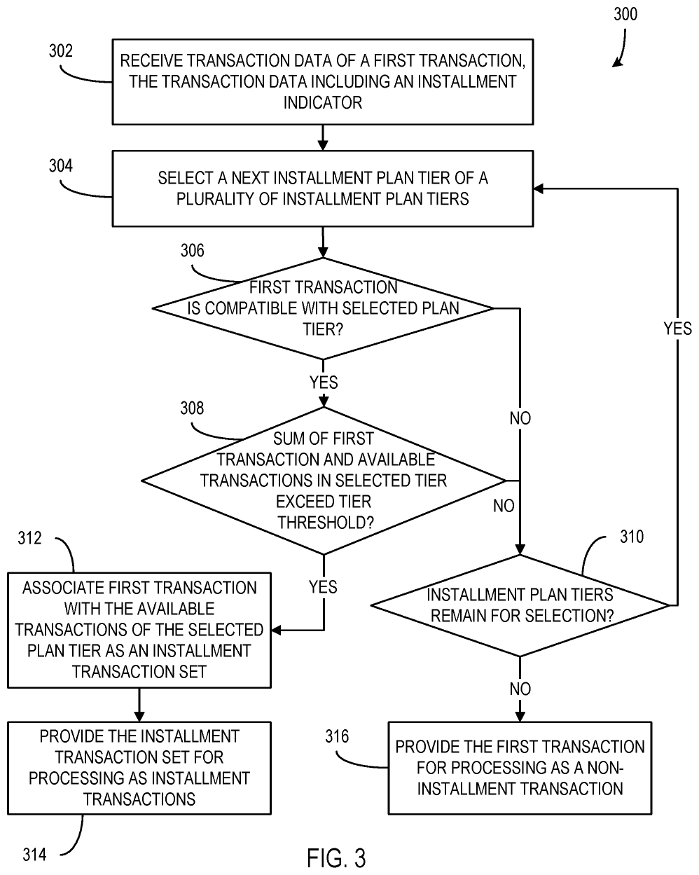

In some examples, the installment plans 126 may be arranged in a priority order, tiers, tranches, or another similar hierarchy arrangement. The higher priority installment plans 126 may be configured to include more advantageous features (e.g., lower interest rates, lower fees, etc.) and/or more stringent transaction requirements (e.g., higher transaction value requirements, stronger user payment history requirements, etc.). The installment plans 126 may be arranged such that, when the transaction analysis engine 122 is identifying matching installment plans 126 for a transaction, the engine 122 may analyze the installment plans 126 according to their priority order. As a result, the engine 122 is more likely to match the transaction with the most favorable installment plan 126 for which the transaction is qualified. This process is described in greater detail below with respect to FIG. 3.

The payment scheduler 124 of the installment plan manager 102 is a component that includes hardware, firmware, or software configured to schedule payments from users 106 and/or 107 associated with transactions of an installment plan 126 to issuers 114 of the installment plan 126. After the transaction value of an installment plan 126 has matched or exceeded the total value threshold 132, the installment plan 126 may be initiated by the installment plan manager 102 and the payment scheduler 124 is configured to schedule payments, communicate with the associated users (106 and/or 107, the users' accounts from which payments will be made, other components of the payment network 112, and associated issuers 114. The payments may be scheduled as defined in the plan features 128 of the installment plan 126 (e.g., 10% of the total payment payed once per month on the 1^{st} of the month with an annual percentage rate (APR) of 5% applied monthly, etc.).

The payment scheduler 124 may be configured to notify a user of an upcoming payment using a contact method provided by the user (e.g., an electronic mail (email) message, an SMS message, a phone call, etc.). Alternatively, or additionally, the user may arrange for automatic withdrawal of a payment from an account and the payment scheduler 124 may be configured to communicate with the financial institution associated with the user's account to arrange the payment to be made when it comes due.

The payment scheduler 124 may further be configured to calculate an amount of each installment payment associated with an initiated payment plan 126. This may include calculating a total amount due for each installment payment based on associated fees and/or interest and calculating a fractional amount due from each user associated with the installment plan 126 based on their associated transactions that make up the installment plan 126.

In some examples, the installment plan manager 102 may be configured to enable users (e.g., user 106, users 107, etc.) to create and use a user profile or the like to arrange to pay for transactions based on installment plans. Users may be enabled to select preferences about installment plans and about what transactions they want to pay for with installments (e.g., setting a preference to automatically apply for installment payments on transactions over $500, setting a preference to only consider installment plans with interest rates lower than 5% APR, etc.). A user's user profile may be linked to the user's credit account, bank account, or other payment account, such that the installment plan manager 102 may perform the operations described herein based on transactions 108 that the user makes with the linked accounts.

Alternatively, or additionally, the installment plan manager 102 may be configured to work with the payment network 112 and/or issuer 114 to provide the installment plan services described herein to users without any previously configured user profile or the like.

In some examples, the installment plan manager 102 is further configured to communicate with the business entities 110 to provide information about the installment plans 126, such that the business entities 110 may deliver the information to users while they shop. For instance, an online merchant entity 110 may receive information regarding an amount an installment payment may be on a particular item, or how much the user's monthly payment would increase upon purchasing an item using installments, etc.

The transactions 134 in the installment transaction data store 104 may include transactions that are part of an initiated installment plan 126, transactions that are being considered for inclusion in an installment plan 126, transactions that have failed to qualify for an installment plan 126, and/or transactions that did not qualify for an installment plan 126 in a required time period. The transactions 134 may be associated with the user 106 or with other users 107. When a user 106 requests that a transaction be considered for an installment plan 126, the installment plan manager 102 may not immediately identify an installment plan 126 for which the transaction is qualified and that has a satisfied total value threshold 132. In some examples, a transaction 108 is transferred to the installment transaction data store 104 and stored as a transaction 134. Transactions 134 may be considered for inclusion in an installment plan 126 for a defined time period and, if a matching installment plan 126 is not identified and initiated within the defined time period, the transaction may be processed as non-installment transaction. In that case, the user 106 may be notified of the failure of the transaction to qualify.

In some examples, when users fail to make their installment payments in a timely fashion or fail to make them at all, the installment plan manager 102 may be configured to store such payment history data for the associated users. If such users request installment payments for transactions in the future, the installment plan manager 102 may be configured to account for the negative payment history data when determining whether the user's transaction matches an installment plan 126 (e.g., transaction requirements 130 may require less than a defined amount of late payments and/or missed payments, etc.). As a result, the user's transaction may only qualify for lower priority installment plans (e.g., higher interest rates, shorter terms, higher fees, etc.). Repeated delinquency of installment payments by a user may result in the installment plan manager 102 locking the user out, thereby causing all future requests for installment payment arrangement to be declined based on the past negative payment behavior.

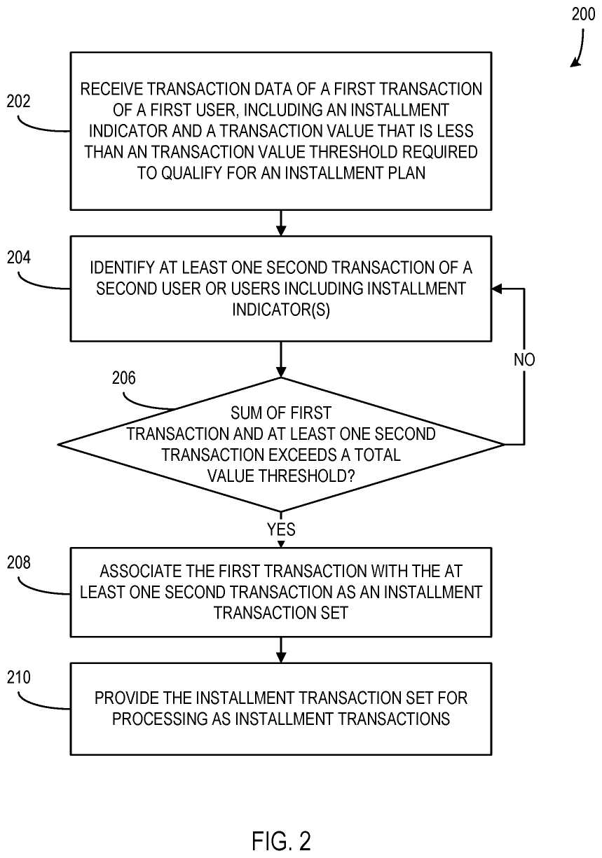

FIG. 2 is an exemplary flow chart 200 illustrating processing of transactions (e.g., transactions 108, 134, etc.) from multiple users (e.g., user 106, users 107, etc.) as installment transactions based on an installment plan (e.g., installment plans 126, etc.) according to an embodiment. In some examples, the illustrated operations may be performed by a system (e.g., system 100, etc.) configured to operate as described herein. At 202, transaction data of a first transaction (e.g., transaction 108, etc.) associated with a first user (e.g., user 106, etc.) is received. The transaction data of the first transaction includes an installment indicator (e.g., installment indicator 116, etc.) and a transaction value (e.g., transaction value 118, etc.), the installment indicator indicating that an installment plan (e.g., installment plan 126, etc.) is requested for the first transaction, and wherein the transaction value is less than a total value threshold (e.g., total value threshold 132, etc.) required to qualify for an installment plan.

At 204, at least one second transaction (e.g., transactions 134, etc.) associated with at least one second user (e.g., users 107, etc.) is identified, wherein the at least one second transaction includes an installment indicator. In some examples, identifying the at least one second transaction includes identifying one or more installment plans for which the first transaction is qualified and identifying other transactions that include installment indicators and that qualify for the same installment plan or plans based on the transaction requirements of the installment plan or plans. Further, if multiple installment plans are found to match the first transaction and the at least one second transactions, the installment plan that is closest to satisfying an associated total value threshold with the inclusion of the first transaction and/or the at least one second transaction. Alternatively, or additionally, an installment plan may be identified and/or selected based on a priority order, tier, or tranche of the installment plan (e.g., an installment plan may be optimized for the transaction by selecting a highest priority matching installment plan over lower priority matching installment plans, etc.).

At 206, if the sum of the first transaction and the at least one second transaction (e.g., the sum of the transaction values of the transactions, etc.) exceeds the total value threshold of the installment plan, the process proceeds to 208. Alternatively, if the sum of the transactions does not exceed the total value threshold, the process returns to 204 to identify more transactions that may be included in the installment plan as described herein.

At 208, the first transaction and the at least one second transaction are associated as an installment transaction set. The installment transaction set may be associated with an installment plan that was previously identified as described above. The installment transaction set comprises all the transactions necessary for initiation of an instance of the associated installment plan. Associating the transactions as a transaction set may include, for instance, assigning or otherwise adding an installment plan identifier to the transaction data of the transactions. Further, date time data or other identifying data may be used to link the transactions together (e.g., an instance of the selected installment plan may be generated to include transaction identifiers of all the transactions to be associated with the installment plan instance, etc.).

At 210, the installment transaction set is provided for processing as installment transactions. An installment plan identifier may also be provided to enable the system 100 to process the installment transactions according to the selected installment plan. The installment transaction set may be provided to a payment network, issuer, or other entity of a payment processing system for processing. In some examples, the installment transaction set and associated installment payments are managed by an installment plan manager as described herein.

FIG. 3 is an exemplary flow chart 300 illustrating processing of transactions from multiple users as installment transactions based on a plurality of installment plans arranged in tiers according to an embodiment. In some examples, a transaction processing system (e.g., system 100, etc.) and/or a particular system component (e.g., payment network 112 and/or installment plan manager 102, etc.) may be configured to perform the operations described in flow chart 300. At 302, transaction data of a first transaction is received. The transaction data includes an installment indicator. This receiving of transaction data may be performed in substantially the same manner as described above with respect to 202 in FIG. 2 above.

At 304, a next installment plan tier of a plurality of installment plan tiers is selected. If it is the first time at 304, the highest priority plan tier is selected. Alternatively, when 304 is repeated, the next highest priority plan tier is selected. A plan tier may include one or more installment plans with similar or the same plan features, transaction requirements, and/or total value thresholds. Higher priority plan tiers may include installment plans with more advantageous plan features and/or more stringent transaction requirements and/or total value thresholds as described herein. By testing installment plan tiers in priority order, the advantages provided to users are optimized, maximizing the priority of the installment plan with which the user's transaction is eventually associated.

If, at 306, the first transaction is compatible with the selected installment plan tier, the process proceeds to 308. Alternatively, if the first transaction is not compatible with the selected installment plan tier, the process proceeds to 310. The first transaction and installment plans in the selected plan tier may be analyzed to determine if the first transaction matches one or more of the installment plans in the plan tier. The analysis may be performed based on transaction requirements of the installment plans, preferences of the user associated with the transaction, analysis of the user's transaction history or payment history, etc. as described herein. If the first transaction matches one or more of the installment plans in the selected plan tier, the first transaction is considered to be compatible with the selected installment plan tier.

At 308, if the sum of the first transaction and other available transaction in the selected plan tier meet or exceed a plan tier total value threshold or a total value threshold specific to an installment plan in the selected plan tier, the process proceeds to 312. Alternatively, if the sum of the associated transactions does not meet or exceed a total value threshold at this plan tier, the process proceeds to 310.

In some examples, the process may include a waiting period associated with the first transaction when identifying a set of available transactions for the selected tier threshold. For instance, rather than immediately moving to the next lower plan tier as described, the process may remain at the current tier for a defined period before proceeding to 310 (e.g., 2 hours, 24 hours, 3 days, etc.). The period of time may be based on the amount of time since the first transaction was initiated, an amount of time since the last installment plan at the selected plan tier was initiated, etc. A waiting time period may be defined based on how long is typically required for an installment plan at the selected tier to acquire sufficient transactions to meet or exceed a total value threshold and be initiated. In some examples, when a user seeks pre-approval for an installment plan for an upcoming transaction, the waiting time period may be several hours. Alternatively, or additionally, when a user seeks approval to an installment plan immediately, the waiting time period may be several seconds or effectively zero, such that the process proceeds immediately to 310 after determining that none of the installment plans in the selected tier are ready to be initiated. It should be understood that the available transactions in the selected plan tier may also be in a defined waiting period prior to attempting to identify a matching installment plan on other tiers.

If the waiting period is very short or effectively zero, matching and/or approval in an installment plan at the selected tier may be provisional, such that the system may predict that an installment plan that matches the transaction will be initiated within a defined period and, upon the installment plan being initiated, the provisionally approved transaction is included in the installment plan. However, if a matching installment plan is not initiated within the defined period the provisionally approved transaction may be processed as a non-installment transaction. It should be understood that a user who receives a provisional approval of a transaction is informed of the possibility of this occurrence prior to the user agreeing to request the provisional approval.

Alternatively, or additionally, transactions that fail to meet the requirements to be processed as installment transactions initially may be stored and, upon a matching installment plan and/or set of other transactions being identified, the transactions that previously failed may be converted to installment transactions by the issuer, payment network, or other party to the transaction. The user may be notified and/or prompted for approval to perform the conversion to an installment transaction.

At 310, if more installment plan tiers remain for selection, the process returns to 304 to select the next installment plan tier as described. Alternatively, if there are no more installment plan tiers to select and a matching installment plan has not been identified for the transaction, the process proceeds to 316. At 316, the first transaction is provided for processing as a non-installment transaction. This may include sending the transaction data to a payment network, issuer, or other entity involved in the transaction such that the transaction is processed according to well-known transaction processing operations. Further, the user may be notified that the request for an installment plan for the transaction has failed and that the transaction is to be processed normally. Such a notification may include contacting the user through a provided contact means (e.g., email, SMS message, phone call, etc.). Alternatively, or additionally, the notification may be displayed on or otherwise communicated with a point-of-sale device (POS) at the business entity when the user requests an installment plan for a transaction at the POS.

If a matching installment plan is identified and the sum of the transactions meets or exceeds the total value threshold at 308, the first transaction is associated with the available transactions of the selected plan tier as an installment transaction set at 312. In some examples, the available transactions with which the first transaction are associated are specifically associated with a particular installment plan of the selected plan tier. Alternatively, or additionally, the available transactions may be associated with the plan tier and they may be dynamically chosen for particular installment plans of the plan tier as those installment plans “fill up” (e.g., acquire transactions such that the total value threshold of the installment plan is met or exceeded, etc.).

Then, the installment transaction set is provided for processing as a set of installment transactions at 314. The providing of the installment transaction set may be performed in substantially the same way as described above with respect to 210 of FIG. 2.

FIG. 4 is an exemplary sequence diagram 400 illustrating processing of transactions from multiple users as installment transactions based on a plurality of installment plans including pre-approving the transactions according to an embodiment. In some examples, the processing described in diagram 400 may be performed within a system (e.g., system 100, etc.) as described herein.

At 402, multiple users 106 may each request installment payment approval for a transaction from the issuer 114. In some examples, the request may be made via a website or other web-enabled computer application (e.g., a mobile device application, etc.) associated with the issuer 114. The users 106 may have user profiles associated with the issuer 114 as described herein and the information in the user profiles may be used during the approval process and/or the transaction processing generally. For instance, the issuer 114 may provide a website to users 106 to create user profiles and link their credit, debit, or other accounts with the issuer 114 to their user profiles, such that installment payment requests may be processed in the context of the linked account information, etc.

At 404, upon the issuer 114 approving the installment payment requests, the issuer 114 informs the payment network 112 of the pre-approved installment transactions. It should be understood that approval of the installment payment requests may include analysis of the transactions with respect to available installment plans as described herein. In some examples, the issuer 114 may include a component (e.g., installment plan manager 102, etc.) configured to perform the transaction analysis prior to contacting the payment network 112 at 404. Alternatively, or additionally, the issuer 114 may provide the transaction data associated with the installment payment request to the payment network 112 for analysis prior to granting pre-approval of the installment payment requests.

At 406, the payment network 112 saves the installment plan and associated transaction data. The saved information may enable the payment network 112 to manage the pre-approved installment transactions when they are initiated and to schedule and manage installment payments associated with the installment transactions as they are processed.

Later, at 408, the users 106 initiate installment transactions at a business entity POS through an acquirer (e.g., a bank or other financial entity associated with the business entity that enables the processing of transactions therewith, etc.). When the transactions reach the payment network 112 during the transaction processing (e.g., during authorization, etc.), the payment network 112 identifies and verifies, at 410, that the transactions are pre-approved installment transactions based on the saved installment plan and transaction data.

At 412, the payment network 112 then provides separate installment payment details for each installment transaction to the issuer 114. The separate installment payment details may be based on the installment plan with which the installment transactions are associated and/or with calculated fractional installment payments for the transactions (e.g., as calculated by a payment scheduler 124, etc.). At 414, the issuer 114 processes the separate installment payments based on the received separate installment payment details as described herein. The issuer 114 may process each instance of separate installment payments as they are initiated throughout the term of the associated installment plan.

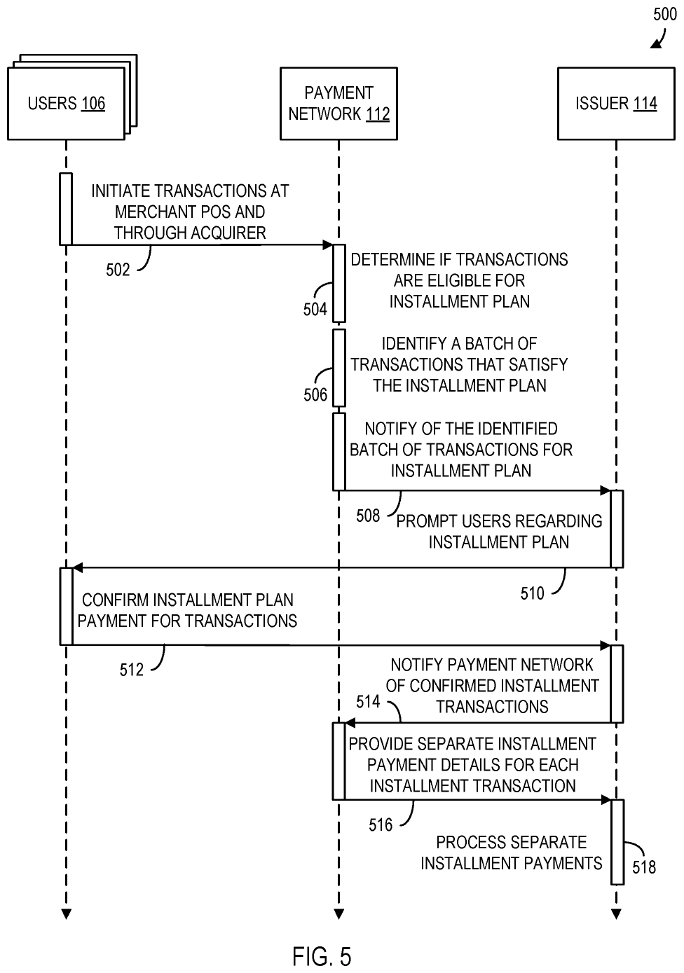

FIG. 5 is an exemplary sequence diagram 500 illustrating processing of transactions from multiple users as installment transactions based on a plurality of installment plans including approving transactions after initiation according to an embodiment. The process of diagram 500 may be performed by a system (e.g., system 100, etc.) as described herein. It should be understood that the processes described may be performed during the processing of the transactions, such as during authorization of the transactions.

At 502, the users 106 initiate transactions at a business entity POS and they are initiated and processed through an acquirer and sent to the payment network 112. At 504, the payment network determines if the transactions are eligible for an installment plan. In some examples, the determination may be based on analysis of the transactions and/or the available installment plans as described herein (e.g., via an installment plan manager 102 and/or a transaction analysis engine 122, etc.). Eligibility of the transaction for an installment plan may be based on transaction requirements associated with the installment plan as well as user preferences of the users 106 associated with the transactions. At 506, the payment network 112 identifies a batch of transactions that satisfy the installment plan. In some examples, the installment plan to be satisfied is an installment plan for which the initiated transactions are eligible. The batch of transactions may include transactions associated with other users 107 currently at a business entity POS and/or transactions that are waiting for installment plan approval through other processes (e.g., the pre-approval process described in FIG. 4, etc.).

At 508, the payment network 112 notifies the issuer 114 of the identified batch of transactions for the installment plan. Then, as part of the authorization process for the transactions, the issuer 114 prompts the users 106 and/or 107 (e.g., via a POS, etc.) to confirm that they are interested in the identified installment plan with respect to the current transaction. In some examples, the prompt may include installment plan details and/or associated payment details (e.g., amount of each installment payment, number of required payments, a term or period for the installment plan, etc.). At 512, the users 106 confirm the installment plan payment for the transactions, which causes a confirmation message to be returned to the issuer 114. At 514, the issuer 114 notifies the payment network 112 that the installment transactions of the identified installment plan have been confirmed by the users 106. The payment network 112 may then provide separate installment payment details for each installment transaction to the issuer 114, at 516, and the issuer 114 may process the separate installment payments, at 518, as previously described with respect to 412-414 of FIG. 4.

In some examples, some transactions of users 106 and 107 may be found to be ineligible for installment plans. In that case, the associated users 106 and 107 may be notified of the ineligibility via the POS and they may be prompted to confirm that the ineligible transactions should be processed as non-installment transactions. The ineligibility of one of the transactions may have little effect on other transactions of other users 106 and/or 107.

Similarly, in some examples, a user 106 may decline the installment plan prompt from the issuer at 512. In that case, the system may be configured to handle the associated transaction as a non-installment transaction when this course of action is confirmed by the user 106. The other transactions that were batched together in the installment plan may be unaffected (e.g., an installment plan may include a feature that enables the plan to continue despite being marginally below a total value threshold based on some users declining at the last moment, etc.). Alternatively, or additionally, the remaining transactions may be provisionally approved for the installment plan and the payment network 112 and/or the associated installment plan management system may be configured to prioritize identification of one or more transactions to complete installment plan instance that is substantially full of provisionally approved transactions.

### Additional Example Scenarios

Aspects of the disclosure enable various additional scenarios, such as next described.

In an example, a first user and a second user both want to opt for installment payments on upcoming purchases. The first user is planning to make a purchase of $200 and the second user is planning to make a purchase of $450. The two users have accounts with the same issuer, who provides an installment plan with a total value threshold of $500 for use with an installment plan management system as described herein. Both users log in to their user profiles with their issuer and apply for installment plan pre-approval. The pre-approval requests are processed as described herein, both transactions are found to match the requirements for the provided installment plan. The system provides the users with confirmation that they are pre-approved for their transactions. Later, the users each go shopping to make their purchases. The first user makes the $200 purchase first, and the installment plan management system stores the transaction information. While the installment plan with which the two transactions are associated is not initiated yet, the system has already pre-approved the $450 transaction, so it is likely that the installment plan total value threshold will be met soon. Once the second user makes the $450 purchase, the associated installment plan is initiated, such that separate installment payments are calculated and scheduled for both users. For instance, an EMI amount of $61.20 may be calculated for the full installment plan, such that the first user pays monthly installments of $18.83 (e.g., the fractional value of the EMI based on the fraction of $200/$650, etc.) and the second user pays monthly installments of $42.37 (e.g., the fractional value of the EMI based on the fraction of $450/$650, etc.). The system may be configured to send notifications to the issuer every month for both users' installment payments, such that the issuer is enabled to post the transactions to the users' accounts. It should be understood that, in an alternative example, the system may be configured such that the installment plan is not initiated until a defined time period has passed, even after both of the pre-approved purchases are made. In this case, the time period may be defined to hold the installment plan open for other qualifying transactions that occur around the same time.

In another example, a third user with an account with another issuer goes shopping and intends to make a $300 purchase after the first and second users obtained pre-approval but before they make their purchases. The installment plan described above includes a feature that enables the combination of transactions associated with either issuer. Upon initiating the $300 purchase at the POS of a business entity, the third user is prompted to indicate interest in making use of the installment plan service. The user confirms interest in paying for the purchase using installment payments. The transaction is sent to the installment plan management system and is analyzed with respect to the installment plan associated with the pre-approved transactions of the first and second users. The system determines that the installment plan matches the third user's transaction and provisionally approves the transaction for inclusion in the installment plan. Because the installment plan only includes one initiated transaction worth $300, the total value threshold is not met. However, the system predicts that the installment plan total value threshold will be satisfied soon, due to already pre-approving the other two transactions. In this case, after the $200 purchase of the first user, the total value threshold of the installment plan is met, but the system may be configured to wait a defined period of time for the other pre-approved transaction to be initiated.

### Exemplary Operating Environment

The present disclosure is operable with a computing apparatus according to an embodiment as a functional block diagram 500 in FIG. 5. In an embodiment, components of a computing apparatus 518 may be implemented as a part of an electronic device according to one or more embodiments described in this specification. The computing apparatus 518 comprises one or more processors 519 which may be microprocessors, controllers or any other suitable type of processors for processing computer executable instructions to control the operation of the electronic device. Platform software comprising an operating system 520 or any other suitable platform software may be provided on the apparatus 518 to enable application software 521 to be executed on the device. According to an embodiment, managing and processing transactions of multiple users as installment transactions according to an installment plan may be accomplished by software.

Computer executable instructions may be provided using any computer-readable media that are accessible by the computing apparatus 518. Computer-readable media may include, for example, computer storage media such as a memory 522 and communications media. Computer storage media, such as a memory 522, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 522) is shown within the computing apparatus 518, it will be appreciated by a person skilled in the art, that the storage may be distributed or located remotely and accessed via a network or other communication link (e.g. using a communication interface 523).

The computing apparatus 518 may comprise an input/output controller 524 configured to output information to one or more output devices 525, for example a display or a speaker, which may be separate from or integral to the electronic device. The input/output controller 524 may also be configured to receive and process an input from one or more input devices 526, for example, a keyboard, a microphone or a touchpad. In one embodiment, the output device 525 may also act as the input device. An example of such a device may be a touch sensitive display. The input/output controller 524 may also output data to devices other than the output device, e.g. a locally connected printing device. In some embodiments, a user may provide input to the input device(s) 526 and/or receive output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Alternatively, or in addition to the other examples described herein, examples include any combination of the following:
A system for enabling the processing multiple transactions from multiple users as installment transactions based on an installment plan, the system comprising:
at least one processor; and
at least one memory comprising computer program code, the at least one memory and the computer program code configured to, with the at least one processor, cause the at least one processor to:
receive, by a first entity, transaction data of a first transaction associated with a first user, wherein the transaction data of the first transaction includes an installment indicator and a transaction value, the installment indicator indicating that an installment plan is requested for the first transaction, and wherein the transaction value is less than a total value threshold required to qualify for the installment plan;
identify at least one second transaction associated with at least one second user, wherein the at least one second transaction includes an installment indicator associated with the installment plan;
based on a sum of the transaction value of the first transaction and at least one transaction value of the at least one second transaction exceeding the total value threshold, associate the first transaction with the at least one second transaction as an installment transaction set associated with the installment plan; and
provide the installment transaction set to a second entity for processing as installment transactions.
wherein the first transaction and the at least one second transaction are associated with different business entities.
wherein the first transaction and the at least one second transaction are associated with an issuer and processing the installment transaction set as installment transactions includes causing installment payments associated with the first transaction and the at least second transaction based on the installment plan to be processed at the issuer.
wherein the installment plan is associated with a plurality of issuers and the first transaction is associated with a first issuer of the plurality of issuers and the at least one second transaction is associated with a second issuer of the plurality of issuers.
the at least one memory and the computer program code configured to, with the at least one processor, further cause the at least one processor to:
identify the installment plan from a plurality of available installment plans based on the first transaction satisfying at least one transaction requirement of the installment plan, wherein each installment plan of the plurality of available installment plans includes at least one transaction requirement and a total value threshold; and
wherein identifying the at least one second transaction includes identifying the at least one second transaction based on the at least one second transaction satisfying the at least one transaction requirement of the identified installment plan.
wherein the plurality of available installment plans includes a priority order and the identified installment plan is a highest installment plan in the priority order that includes at least one transaction requirement satisfied by the first transaction.
wherein the identified installment plan is provided to the first user and confirmation is received from the first user based on an installment transaction pre-approval process prior to initiation of the first transaction with a business entity.
wherein the identified installment plan is provided to the first user and confirmation is received from the first user via a point-of-sale (POS) terminal during initiation of the first transaction with a business entity.
wherein the at least one transaction requirement of the installment plan is based on a transaction history data of the first user.
A computerized method for enabling the processing multiple transactions from multiple users as installment transactions based on an installment plan, the method comprising:
receiving, by a processor of a first entity, transaction data of a first transaction associated with a first user, wherein the transaction data of the first transaction includes an installment indicator and a transaction value, the installment indicator indicating that an installment plan is requested for the first transaction, and wherein the transaction value is less than a total value threshold required to qualify for the installment plan;
identifying, by the processor, at least one second transaction associated with at least one second user, wherein the at least one second transaction includes an installment indicator associated with the installment plan;
based on a sum of the transaction value of the first transaction and at least one transaction value of the at least one second transaction exceeding the total value threshold, associating, by the processor, the first transaction with the at least one second transaction as an installment transaction set associated with the installment plan; and
providing, by the processor, the installment transaction set to a second entity for processing as installment transactions.
wherein the first transaction and the at least one second transaction are associated with different business entities.
wherein the first transaction and the at least one second transaction are associated with an issuer and processing the installment transaction set as installment transactions includes causing installment payments associated with the first transaction and the at least second transaction based on the installment plan to be processed at the issuer.
wherein the installment plan is associated with a plurality of issuers and the first transaction is associated with a first issuer of the plurality of issuers and the at least one second transaction is associated with a second issuer of the plurality of issuers.
identifying the installment plan from a plurality of available installment plans based on the first transaction satisfying at least one transaction requirement of the installment plan, wherein each installment plan of the plurality of available installment plans includes at least one transaction requirement and a total value threshold; and
wherein identifying the at least one second transaction includes identifying the at least one second transaction based on the at least one second transaction satisfying the at least one transaction requirement of the identified installment plan.
wherein the plurality of available installment plans includes a priority order and the identified installment plan is a highest installment plan in the priority order that includes at least one transaction requirement satisfied by the first transaction.
wherein the identified installment plan is provided to the first user and confirmation is received from the first user based on an installment transaction pre-approval process prior to initiation of the first transaction with a business entity.
wherein the identified installment plan is provided to the first user and confirmation is received from the first user via a point-of-sale (POS) terminal during initiation of the first transaction with a business entity.
wherein the at least one transaction requirement of the installment plan is based on at least one of transaction history data of the first user.
One or more computer storage media having computer-executable instructions for enabling the processing multiple transactions from multiple users as installment transactions based on an installment plan that, upon execution by a processor, cause the processor to at least:
receive, by a first entity, transaction data of a first transaction associated with a first user, wherein the transaction data of the first transaction includes an installment indicator and a transaction value, the installment indicator indicating that an installment plan is requested for the first transaction, and wherein the transaction value is less than a total value threshold required to qualify for the installment plan;
identify at least one second transaction associated with at least one second user, wherein the at least one second transaction includes an installment indicator associated with the installment plan;
based on a sum of the transaction value of the first transaction and at least one transaction value of the at least one second transaction exceeding the total value threshold, associate the first transaction with the at least one second transaction as an installment transaction set associated with the installment plan; and
provide the installment transaction set to a second entity for processing as installment transactions.
identify the installment plan from a plurality of available installment plans based on the first transaction satisfying at least one transaction requirement of the installment plan, wherein each installment plan of the plurality of available installment plans includes at least one transaction requirement and a total value threshold; and
wherein identifying the at least one second transaction includes identifying the at least one second transaction based on the at least one second transaction satisfying the at least one transaction requirement of the identified installment plan.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for receiving, by a first entity, transaction data of a first transaction associated with a first user, wherein the transaction data of the first transaction includes an installment indicator and a transaction value, the installment indicator indicating that an installment plan is requested for the first transaction, and wherein the transaction value is less than a total value threshold required to qualify for the installment plan, means for identifying at least one second transaction associated with at least one second user, wherein the at least one second transaction includes an installment indicator associated with the installment plan, means for, based on a sum of the transaction value of the first transaction and at least one transaction value of the at least one second transaction exceeding the total value threshold, associating the first transaction with the at least one second transaction as an installment transaction set associated with the installment plan, and means for providing the installment transaction set to a second entity for processing as installment transactions. The illustrated one or more processors 519 together with the computer program code stored in memory 522 constitute exemplary processing means for analyzing transaction data with respect to installment plans and managing and scheduling associated installment payments as described herein.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for enabling the processing of multiple transactions from multiple users as installment transactions based on an installment plan, the system comprising:
at least one processor; and
at least one memory comprising computer program code, the at least one memory and the computer program code configured to, with the at least one processor, cause the at least one processor to:
receive, by a first entity, transaction data of a first transaction associated with a first user, wherein the transaction data of the first transaction includes an installment indicator and a transaction value, the installment indicator indicating that an installment plan is requested for the first transaction, and wherein the transaction value is less than a total value threshold required to qualify for the installment plan;
identify at least one second transaction associated with at least one second user, wherein the at least one second transaction includes an installment indicator associated with the installment plan;
based on a sum of the transaction value of the first transaction and at least one transaction value of the at least one second transaction exceeding the total value threshold, associate the first transaction with the at least one second transaction as an installment transaction set associated with the installment plan; and
provide the installment transaction set to a second entity for processing as installment transactions.

2. The system of claim 1, wherein the first transaction and the at least one second transaction are associated with different business entities.

3. The system of claim 1, wherein the first transaction and the at least one second transaction are associated with an issuer and processing the installment transaction set as installment transactions includes causing installment payments associated with the first transaction and the at least second transaction based on the installment plan to be processed at the issuer.

4. The system of claim 1, wherein the installment plan is associated with a plurality of issuers and the first transaction is associated with a first issuer of the plurality of issuers and the at least one second transaction is associated with a second issuer of the plurality of issuers.

5. The system of claim 1, the at least one memory and the computer program code configured to, with the at least one processor, further cause the at least one processor to:
identify the installment plan from a plurality of available installment plans based on the first transaction satisfying at least one transaction requirement of the installment plan, wherein each installment plan of the plurality of available installment plans includes at least one transaction requirement and a total value threshold; and
wherein identifying the at least one second transaction includes identifying the at least one second transaction based on the at least one second transaction satisfying the at least one transaction requirement of the identified installment plan.

6. The system of claim 5, wherein the plurality of available installment plans includes a priority order and the identified installment plan is a highest installment plan in the priority order that includes at least one transaction requirement satisfied by the first transaction.

7. The system of claim 5, wherein the identified installment plan is provided to the first user and confirmation is received from the first user based on an installment transaction pre-approval process prior to initiation of the first transaction with a business entity.

8. The system of claim 5, wherein the identified installment plan is provided to the first user and confirmation is received from the first user via a point-of-sale (POS) terminal during initiation of the first transaction with a business entity.

9. The system of claim 5, wherein the at least one transaction requirement of the installment plan is based on a transaction history data of the first user.

10. A computerized method for enabling the processing of multiple transactions from multiple users as installment transactions based on an installment plan, the method comprising:
receiving, by a processor of a first entity, transaction data of a first transaction associated with a first user, wherein the transaction data of the first transaction includes an installment indicator and a transaction value, the installment indicator indicating that an installment plan is requested for the first transaction, and wherein the transaction value is less than a total value threshold required to qualify for the installment plan;
identifying, by the processor, at least one second transaction associated with at least one second user, wherein the at least one second transaction includes an installment indicator associated with the installment plan;
based on a sum of the transaction value of the first transaction and at least one transaction value of the at least one second transaction exceeding the total value threshold, associating, by the processor, the first transaction with the at least one second transaction as an installment transaction set associated with the installment plan; and
providing, by the processor, the installment transaction set to a second entity for processing as installment transactions.

11. The computerized method of claim 10, wherein the first transaction and the at least one second transaction are associated with different business entities.

12. The computerized method of claim 10, wherein the first transaction and the at least one second transaction are associated with an issuer and processing the installment transaction set as installment transactions includes causing installment payments associated with the first transaction and the at least second transaction based on the installment plan to be processed at the issuer.

13. The computerized method of claim 10, wherein the installment plan is associated with a plurality of issuers and the first transaction is associated with a first issuer of the plurality of issuers and the at least one second transaction is associated with a second issuer of the plurality of issuers.

14. The computerized method of claim 10, the method further comprising:
identifying the installment plan from a plurality of available installment plans based on the first transaction satisfying at least one transaction requirement of the installment plan, wherein each installment plan of the plurality of available installment plans includes at least one transaction requirement and a total value threshold; and
wherein identifying the at least one second transaction includes identifying the at least one second transaction based on the at least one second transaction satisfying the at least one transaction requirement of the identified installment plan.

15. The computerized method of claim 14, wherein the plurality of available installment plans includes a priority order and the identified installment plan is a highest installment plan in the priority order that includes at least one transaction requirement satisfied by the first transaction.

16. The computerized method of claim 14, wherein the identified installment plan is provided to the first user and confirmation is received from the first user based on an installment transaction pre-approval process prior to initiation of the first transaction with a business entity.

17. The computerized method of claim 14, wherein the identified installment plan is provided to the first user and confirmation is received from the first user via a point-of-sale (POS) terminal during initiation of the first transaction with a business entity.

18. The computerized method of claim 14, wherein the at least one transaction requirement of the installment plan is based on at least one of transaction history data of the first user.

19. One or more computer storage media having computer-executable instructions for enabling the processing of multiple transactions from multiple users as installment transactions based on an installment plan that, upon execution by a processor, cause the processor to at least:
receive, by a first entity, transaction data of a first transaction associated with a first user, wherein the transaction data of the first transaction includes an installment indicator and a transaction value, the installment indicator indicating that an installment plan is requested for the first transaction, and wherein the transaction value is less than a total value threshold required to qualify for the installment plan;
identify at least one second transaction associated with at least one second user, wherein the at least one second transaction includes an installment indicator associated with the installment plan;
based on a sum of the transaction value of the first transaction and at least one transaction value of the at least one second transaction exceeding the total value threshold, associate the first transaction with the at least one second transaction as an installment transaction set associated with the installment plan; and
provide the installment transaction set to a second entity for processing as installment transactions.

20. The one or more computer storage media of claim 19, wherein the computer-executable instructions, upon execution by a processor, further cause the processor to at least:
identify the installment plan from a plurality of available installment plans based on the first transaction satisfying at least one transaction requirement of the installment plan, wherein each installment plan of the plurality of available installment plans includes at least one transaction requirement and a total value threshold; and
wherein identifying the at least one second transaction includes identifying the at least one second transaction based on the at least one second transaction satisfying the at least one transaction requirement of the identified installment plan.
